(19) United States
(12) Patent Application Publication
(10) Pub. No.: US 2014/0019570 A1
(43) Pub. Date: Jan. 16, 2014

(54) DATA BUFFER EXCHANGE

(71) Applicant: Danielle J. Marchione, Dulles, VA (US)

(72) Inventor: Danielle J. Marchione, Dulles, VA (US)

(73) Assignee: RAYTHEON COMPANY, Waltham, MA (US)

(21) Appl. No.: 13/547,632

(22) Filed: Jul. 12, 2012

(51) Int. Cl. G06F 15/167

(52) U.S. Cl. 709/212

(57) ABSTRACT

A method for transferring data between nodes includes receiving in an input buffer of a first node, a direct memory access (DMA) thread that includes a first data element the input buffer associated with a second node, receiving a first message from the second node indicative of an address of the input buffer containing the first data element, and saving the address of the input buffer containing the first data element to a first list responsive to receiving the first message.

### BACKGROUND

The present invention relates to data systems, and more specifically, to the exchange of data in buffers of data systems.

Many data systems include a plurality of nodes that each include processing elements. The processing elements perform data processing tasks on data stored in a memory location that may be shared or accessible to a variety of the nodes. The integrity of the data stored in the shared memory location is maintained by a memory management scheme.

### SUMMARY

According to one embodiment of the present invention, a method for transferring data between nodes includes receiving in an input buffer of a first node, a direct memory access (DMA) thread that includes a first data element the input buffer associated with a second node, receiving a first message from the second node indicative of an address of the input buffer containing the first data element, and saving the address of the input buffer containing the first data element to a first list responsive to receiving the first message.

According to another embodiment of the present invention, a processing node includes a memory device, and a processor operative to perform a method comprising receiving in an input buffer of a first node, a direct memory access (DMA) thread that includes a first data element, the input buffer associated with a second node, receiving a first message from the second node indicative of an address of the input buffer containing the first data element, and saving the address of the input buffer containing the first data element to a first list responsive to receiving the first message.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a block diagram of an exemplary embodiment of a data network system.

FIG. 2 illustrates a block diagram of an exemplary node.

FIGS. 3A-3F illustrate an exemplary embodiment of a node and a method of operation of the node in the data system of FIG. 1.

FIGS. 4A-4G illustrate an exemplary embodiment of a node that includes a FPGA and a method of operation of the node in the data system of FIG. 1.

FIGS. 5A-5F illustrate an exemplary embodiment of a node that includes a graphics processing unit GPU and a method of operation of the node in the data system of FIG. 1.

### DETAILED DESCRIPTION

The embodiments described below include systems and methods for processing data elements in a distributed environment of heterogeneous processing elements. In this regard, shared memory approaches may not provide the desired performance goals. The desired net processing times of such a system may be achieved by avoiding the use of traditional network message schemes that communicate the locations and availabilities of data.

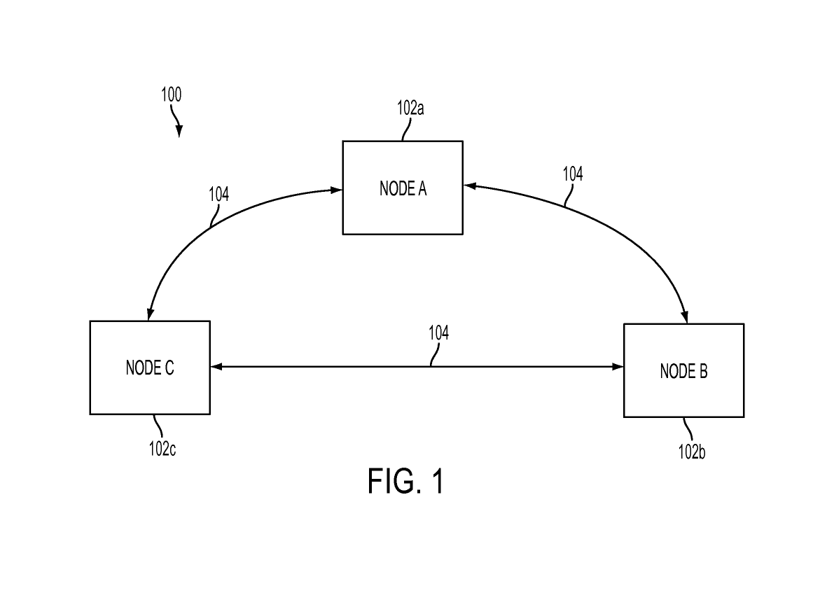

FIG. 1 illustrates a block diagram of an exemplary embodiment of a data network system 100 that includes nodes 102a-c that are communicatively connected via links 104. The links 104 may include any type of data connection such as, for example, direct memory access (DMA) connections including peripheral component interconnect (PCI) or PCI express (PCIe). Alternatively, in some alternate exemplary embodiments, other data connections such as, Ethernet connections may be included between the nodes 102. Using a DMA scheme to transfer data between nodes offers a high data transfer rates. However, the data transfer rates may be reduced if available bandwidth is consumed inefficiently. The exemplary methods and systems described below offer efficient data transfer between nodes using a DMA scheme.

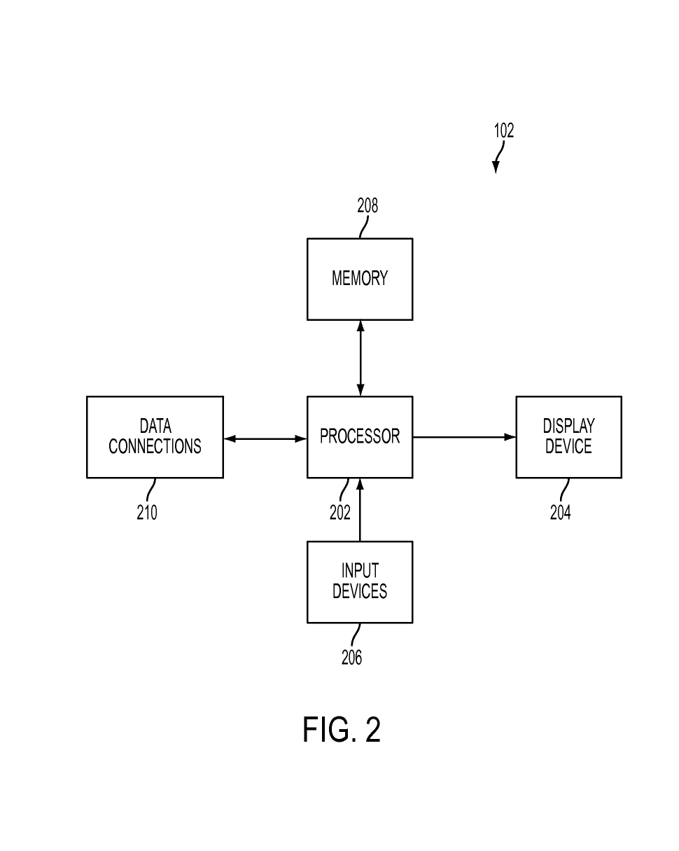

FIG. 2 illustrates a block diagram of an exemplary node 102 that includes a processor 202 that is communicatively connected to a display device 204, input devices 206, memory 208, and data connections. The exemplary nodes 102 described herein may include some or all of the elements described in FIG. 2. Alternatively, exemplary nodes 102 may include a field programmable gate array (FPGA) type processor or a graphics processing unit (GPU) type processor.

In this regard, the data system 100 may operate to process data elements without using a shared memory management system. A data element includes any data that may be input to a processor that performs a processing task that results in an output data element. During operation, a data element is saved locally in a memory on a first node 102a as an input data element. The first node 102a processes the input data element to generate an output data element. The first node 102a outputs the output data element to a second node 102b by saving the output data element in a memory device located in the second node 102b. The data is saved by the first node 102a on the memory device of the second node 102b using a DMA thread send by the first node 102a to the memory device of the second node 102b. Each node 102 includes a memory device having portions of memory allocated to specific nodes 102 of the system 100. Thus, the memory device of the second node 102b includes memory locations allocated to the first node 102a (and, in the example shown in FIG. 1, a three node system, memory locations allocated to the third node 102c). The memory locations allocated to a particular node may only be written to by the particular node 102, and may be read by the local node 102. For example, the memory device of the second node 102b has memory locations allocated to the first node 102a and memory locations allocated to the third node 102c. The first node 102a may write to the memory locations on the second node 102c that are allocated to the first node 102a using a DMA thread. The third node 102c may write to the memory locations on the second node 102b allocated to the second node 102b using a DMA thread. The second node 102b may retrieve data from the memory locations on the second node 102b that are allocated to either the first node 102b or the third node 102c and process the retrieved data. Once the data is processed by the second node 102b, the second node 102b may output the processed data element externally (e.g., on a display to a user) or may output the processed data element to either the first node 102a or the third node 102c by writing the processed data element to a memory location allocated to the second node 102b on the first node 102a or the third node 102c.

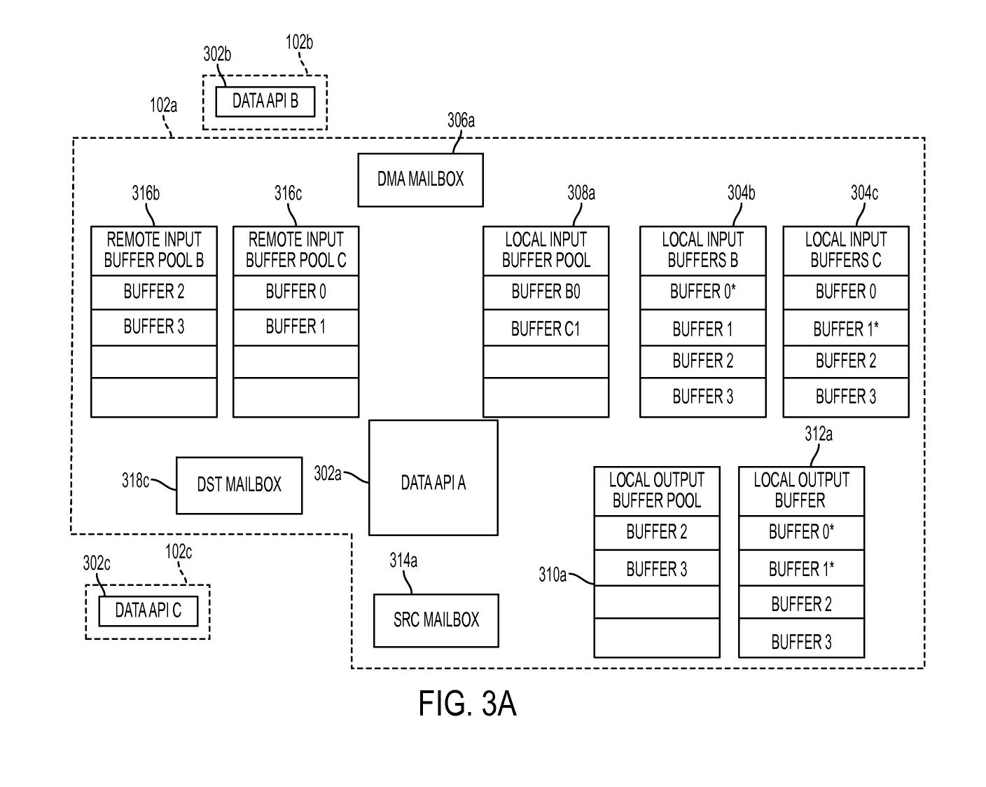

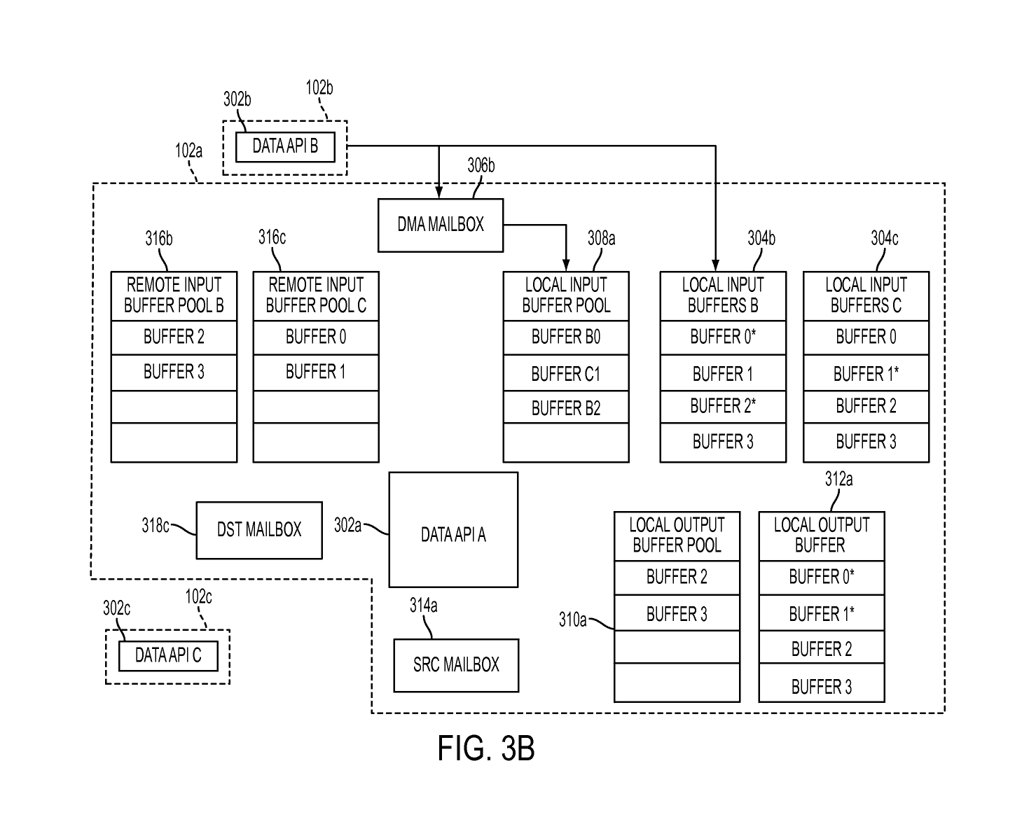

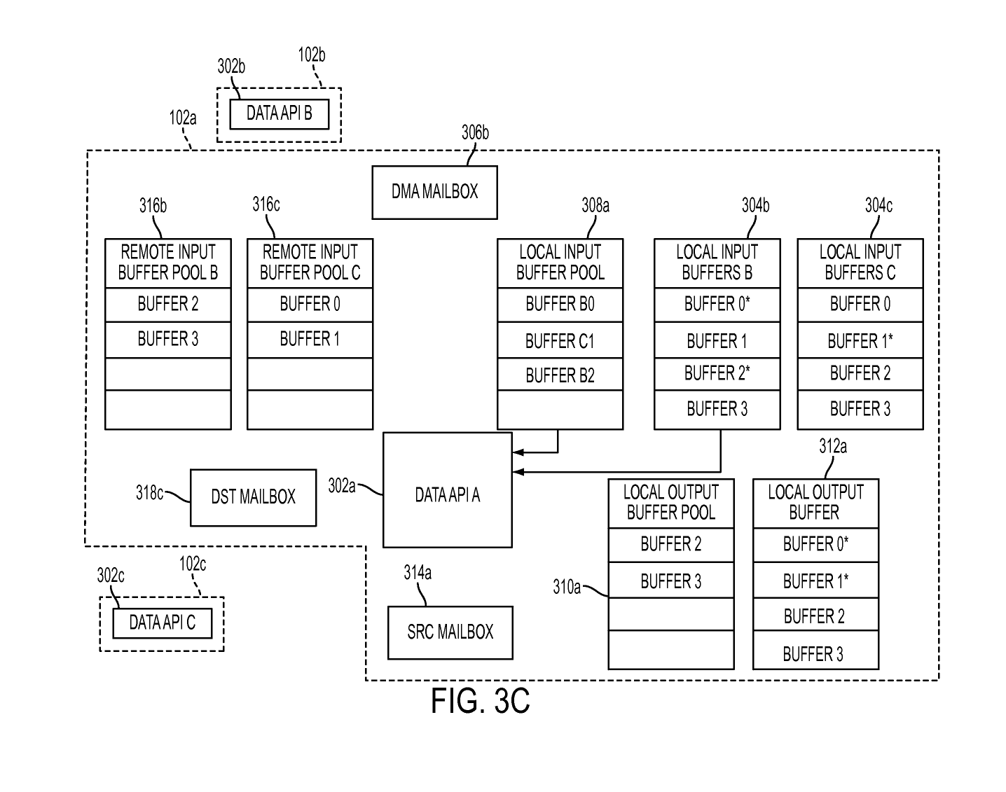

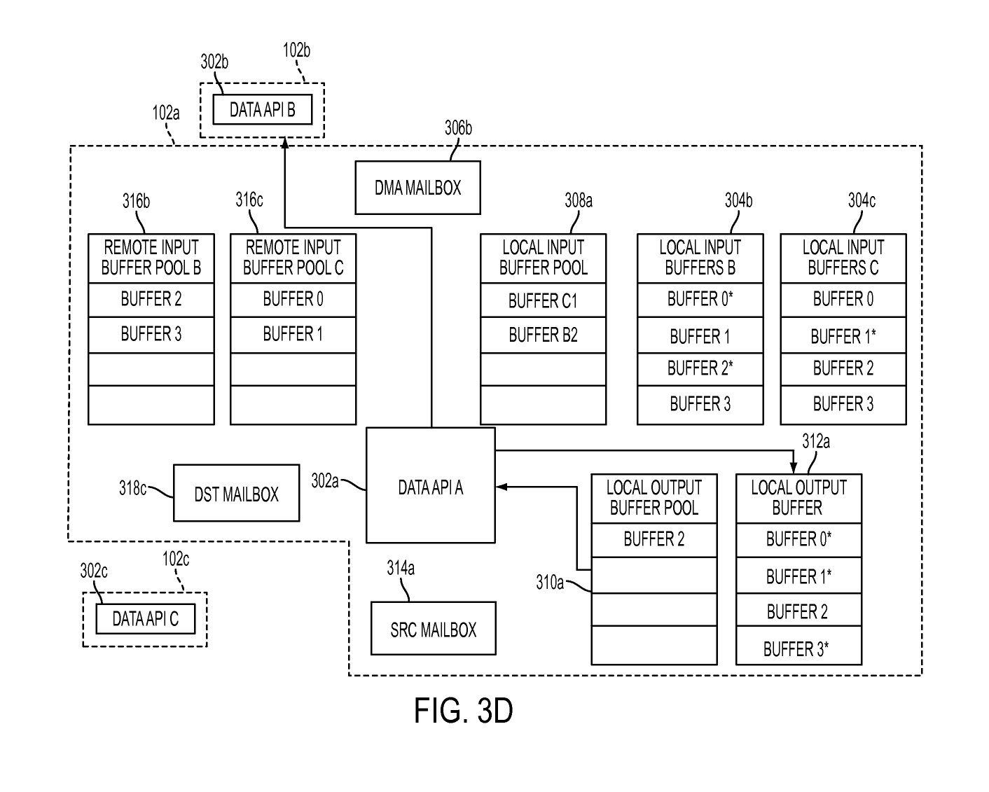

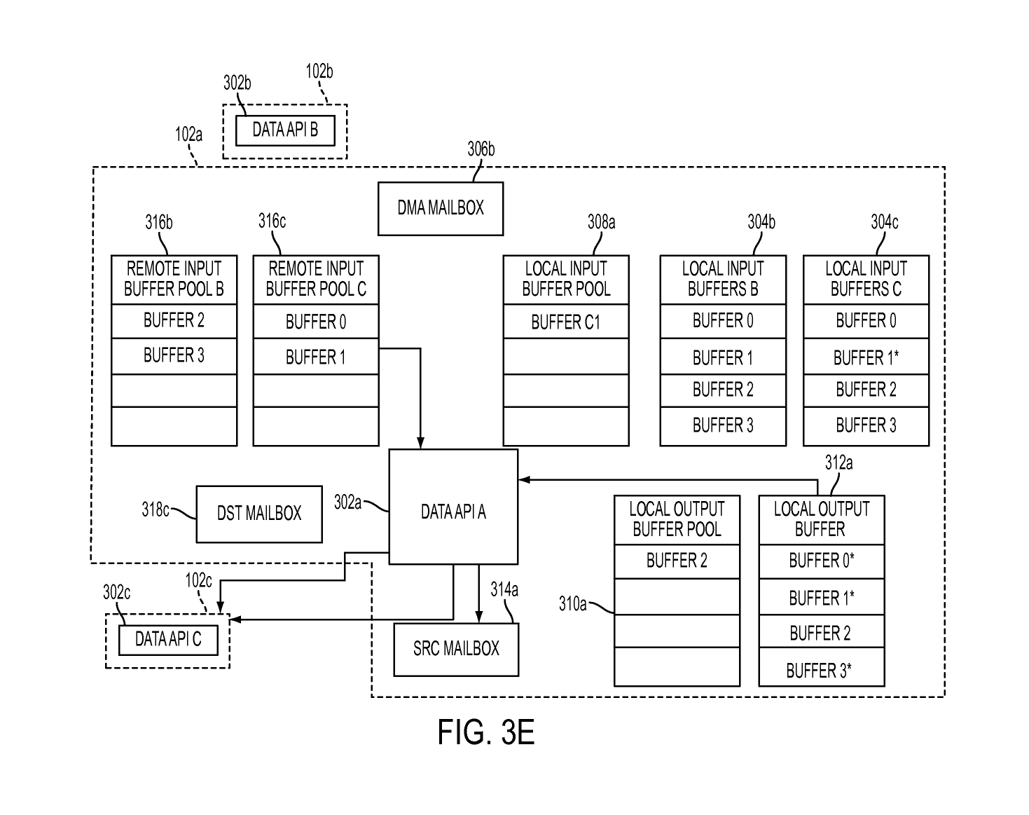

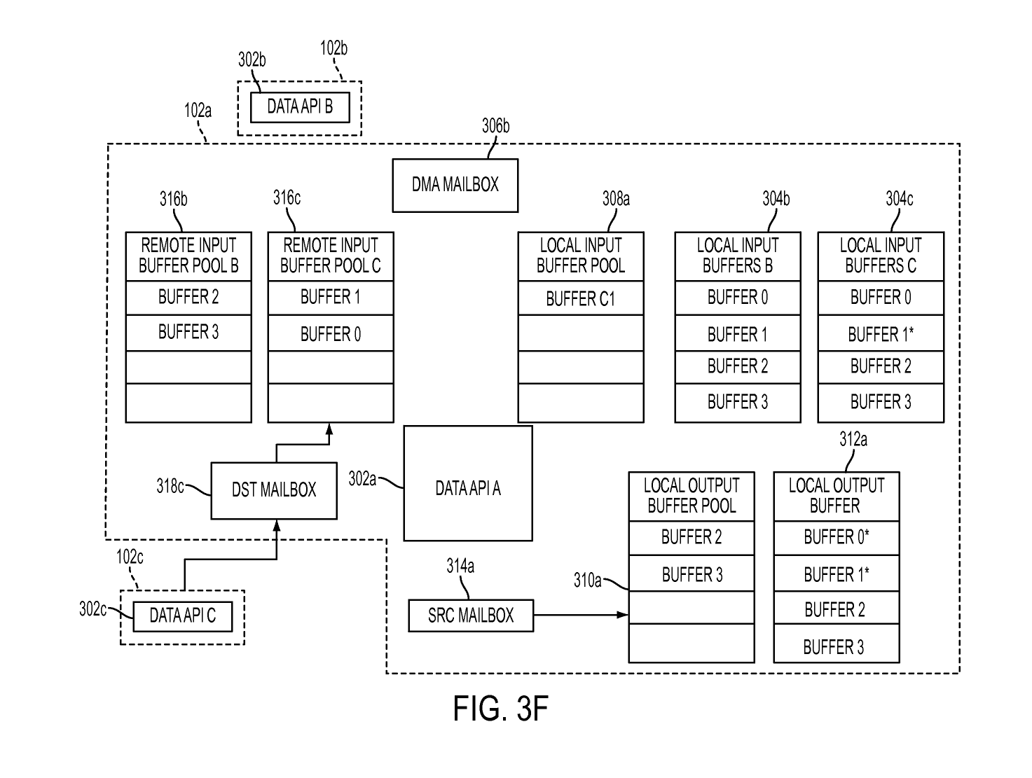

FIGS. 3A-3F illustrate an exemplary embodiment of a node 102a and a method of operation of the node 102 in the data system 100 (of FIG. 1). Referring to FIG. 3A, the node 102a includes local input buffers B 304b and C 304c that each include a plurality of buffers allocated to the nodes 102b and 102c respectively. The local input buffers 304b and 304c are located in a local memory 208 (of FIG. 2) of the node 102a. The local input buffer pool 308a includes a table or list of addresses (i.e., buffers) in the local input buffers 304b and 304c that include data elements that are queued to be processed by the node 102a. For example, the local input buffers 304b and 304c include buffers marked for illustrative purposes with an “*” indicating that the buffers hold one or more data elements for processing locally in the node 102a. The local input buffer pool 308 includes a list of the locations in the local input buffers 304b and 304c that hold the data elements for processing.

The local output buffer 312a includes a plurality of buffers located in a local memory 208 (of FIG. 2) of the node 102a. The local output buffer 312a receives data elements following processing by the node 102a. For example, the local output buffer 312a includes buffers marked for illustrative purposes with an “*” indicating that the buffers hold one or more data elements that are ready to be output to another node. The local output buffer pool 310a includes a list of the locations in the local output buffer 312a that are “empty” or available to be used to store processed data elements that will be output to another node 102.

The remote input buffer pools B 316b and C 316c indicate which memory locations in the local input buffers allocated to the node 102a and located in the nodes 102b and 102c are empty or available to be used to store data elements output from the node 102a to the respective nodes 102b and 102c (for processing by the nodes 102b and 102c). The operation of the node 102a will be described in further detail below.

In this regard, referring to FIG. 3B, the node 102b has saved a data element in the buffer 2 of the local input buffer B 304b as indicated for illustrative purposes by the “*” in buffer 2. The node 102b sends a message to the DMA mailbox 306b of the node 102a that indicates that the buffer 2 contains a data element for processing by the node 102a. The local buffer pool 308a of the node 102a periodically retrieves the messages received in the DMA mailbox and updates the local input buffer pool list 308a. In the illustrated example, the local input buffer pool 308a has been updated in FIG. 3B to reflect the presence of a saved data element in buffer 2 of the local input buffer B 304b.

Referring to FIG. 3C, the data (application programming interface) API 302a of node 102a retrieves data elements for processing from the local input buffers 304 by referring to the local input buffer pool 308a. In the illustrated example, the data API 302a retrieves an address of a buffer from the local input buffer pool 308a (e.g., buffer B0) and retrieves the data element in the buffer 0 of the local input buffer B 304b for processing.

Referring to FIG. 3D, when the data API 302a retrieves the data element from a local input buffer, the API 302a removes the indication that the buffer in the local input buffers B 304 holds an unprocessed data element by removing the address from the local input buffer pool 308a (e.g., the “Buffer B0” address is removed). When the data API 302a retrieves the data element from the local input buffer, the node 102a may process the data element and output the processed data element to a location in the local output buffer 312a. In this regard, the data API 302a retrieves an available memory location, i.e., buffer, from the local output buffer pool 310a that includes a listing of the “empty” buffers that may be written to in the local output buffer 312a. When the data API 302a saves the processed data element to the local output buffer 312a, the local output buffer pool 310a is updated to remove the “empty” address listing in the local output buffer pool 310a. Thus, the data API 302a only writes processed data elements to available locations local output buffer 312a by referring to the local output buffer pool 310a. The API 302a sends a message indicating that the “Buffer B0” is available to be written to by the node 302b to the node 302b once the data element is stored in the local output buffer 312a. Thus, the node 302b may be made aware that a memory location i.e., buffer is “empty” and may overwritten or used to store another data element output by the node 102b to the node 102a for processing by the node 102a.

Referring to FIG. 3E, the API 302a retrieves data from the local output buffer 312a and sends the data to another node (a receiving node) in the system 100. In the illustrated example, the data API 302a has retrieved a processed data element from the buffer 3 location of the local output buffer 312a to save the processed data element in the receiving node, node 102c. The API 302a determines whether the local input buffer of the node 102c allocated to the node 102a (e.g., local input buffers A, not shown) has a buffer that is “empty” or available to save the processed data element by retrieving an available address from the remote input buffer pool C 316c that indicates the addresses that are available in the local input buffers A of the node 102c. When an address is available as indicated by the presence of the address in the remote input buffer pool C 316c (e.g., buffer 0 in the remote input buffer pool C 316c shown in FIG. 3E), the data API 302a removes the address from the remote input buffer pool C 316c and uses the address to generate a DMA thread with the processed data element in the local output buffer (e.g., The processed data element stored in the buffer 3 of the local output buffer 312a is sent to the address stored in the buffer 0 remote input buffer pool 316c.). When the data API 302a saves the processed data element in the buffer 0 of the local input buffer of the node 102c, the data API 302a sends a message to the source (src) mailbox 314a indicating that the buffer 3 of the local output buffer 312a is available to be overwritten. The data API 302a also sends a message to the DMA mailbox of the receiving node, node 102c that may be used to update the local input buffer pool of the receiving node, 102c as described above.

Referring to FIG. 3F, the local output buffer pool 310a has been updated by retrieving the message from the src mailbox 314a that indicates that the buffer 3 of the local output buffer 312a is “empty” or available to be overwritten. Once the node 102c has processed the received data element, by retrieving the received data element from the buffer 0 of the local input buffer A in the node 102c (not shown), the node 102c sends a message to the destination (dst) mailbox 318c of the node 102a that indicates that the buffer 0 of the local input buffer A in the node 102c is “empty” or available to be overwritten. The remote input buffer pool C 316c may be updated by receiving the message from the dst mailbox 318c and adding the buffer 0 to the list in the remote input buffer pool C 316c.

Though the illustrated embodiment of FIG. 3 illustrates one dst mailbox 318c, alternate embodiments may include a plurality of dst mailboxes 318 that correspond to respective remote input buffer pools 316. Thus, each remote input buffer pool 316 maintained on a node 102 may be associated with a corresponding dst mailbox 318 on the node 102.

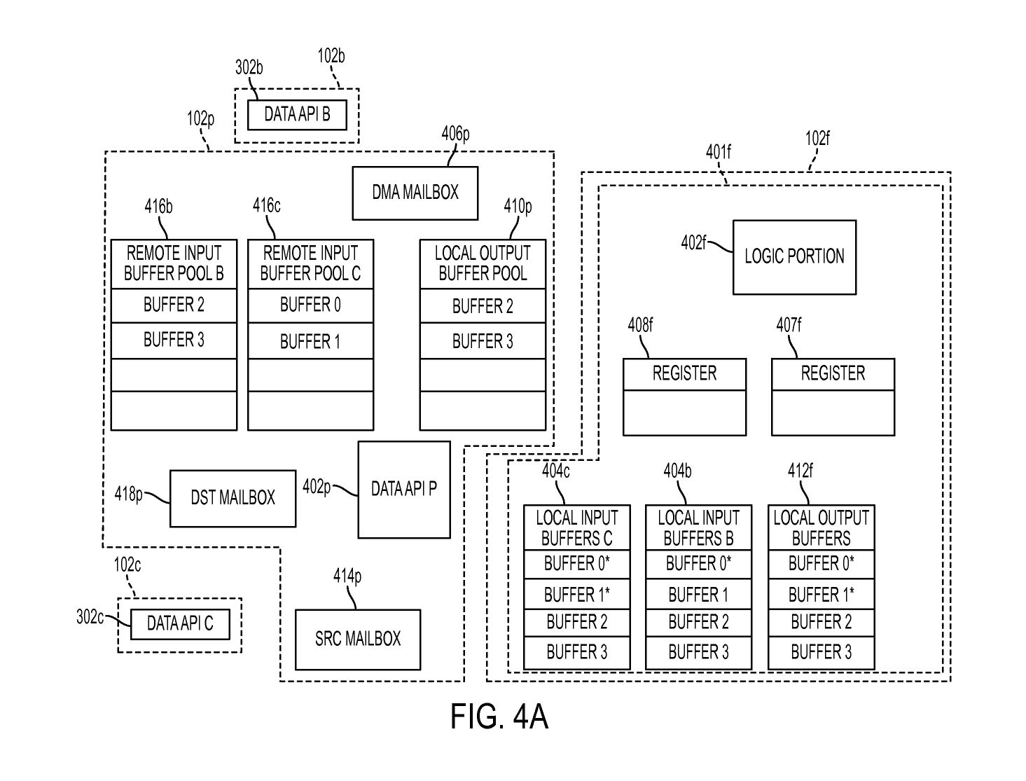

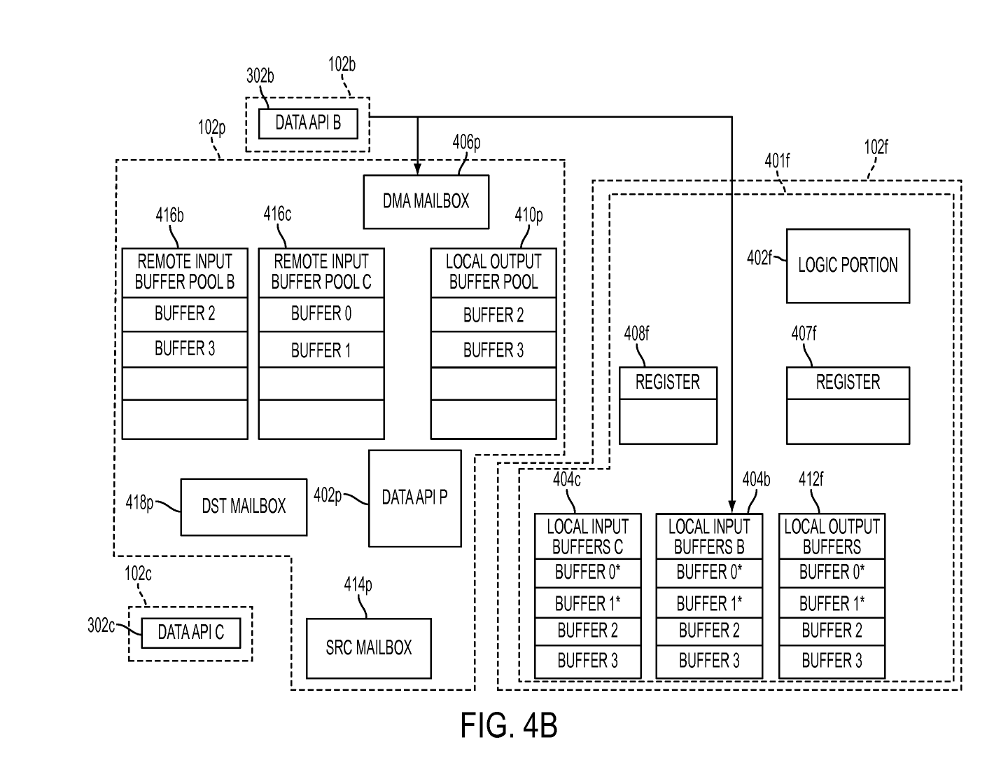

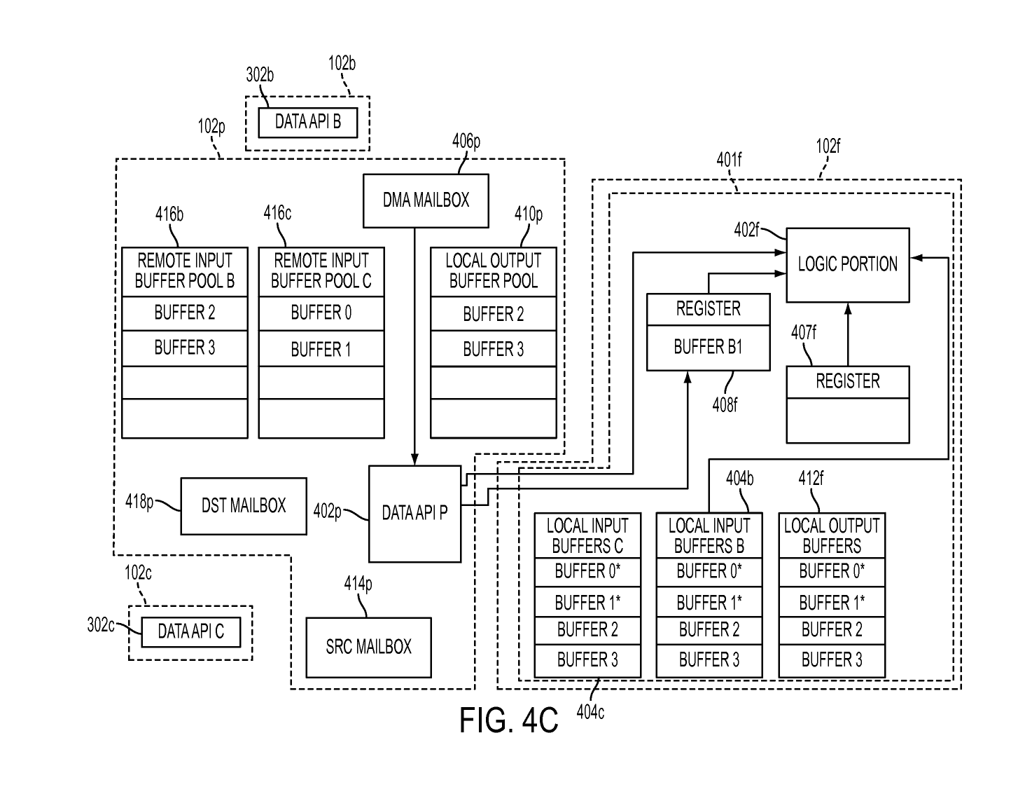

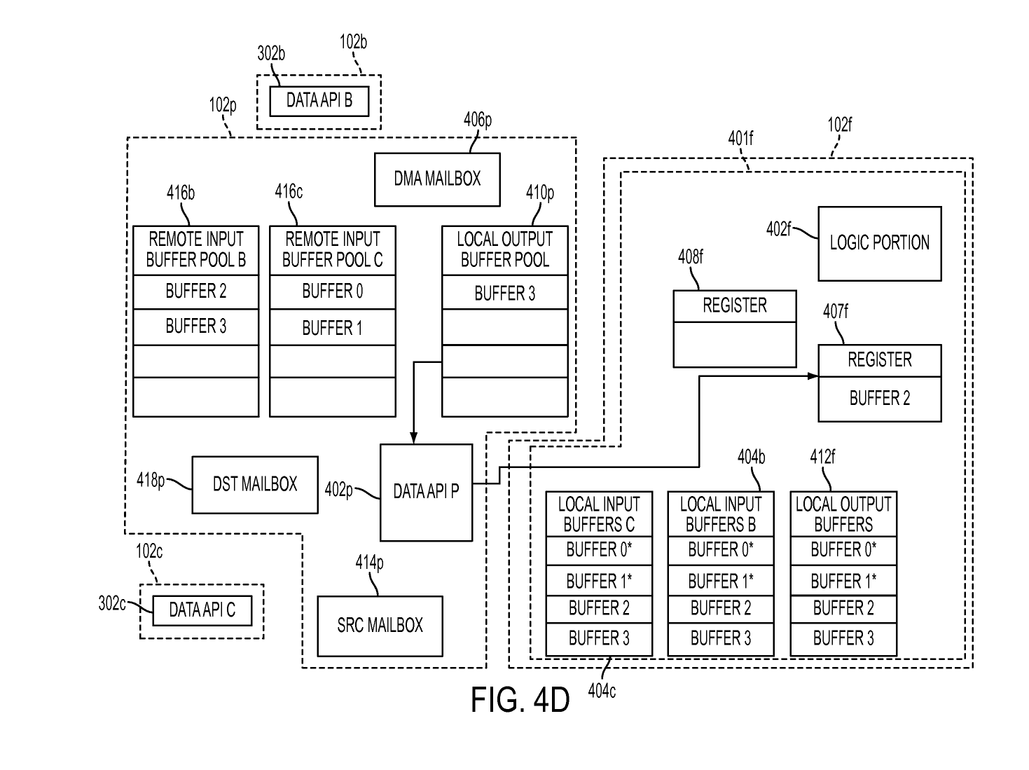

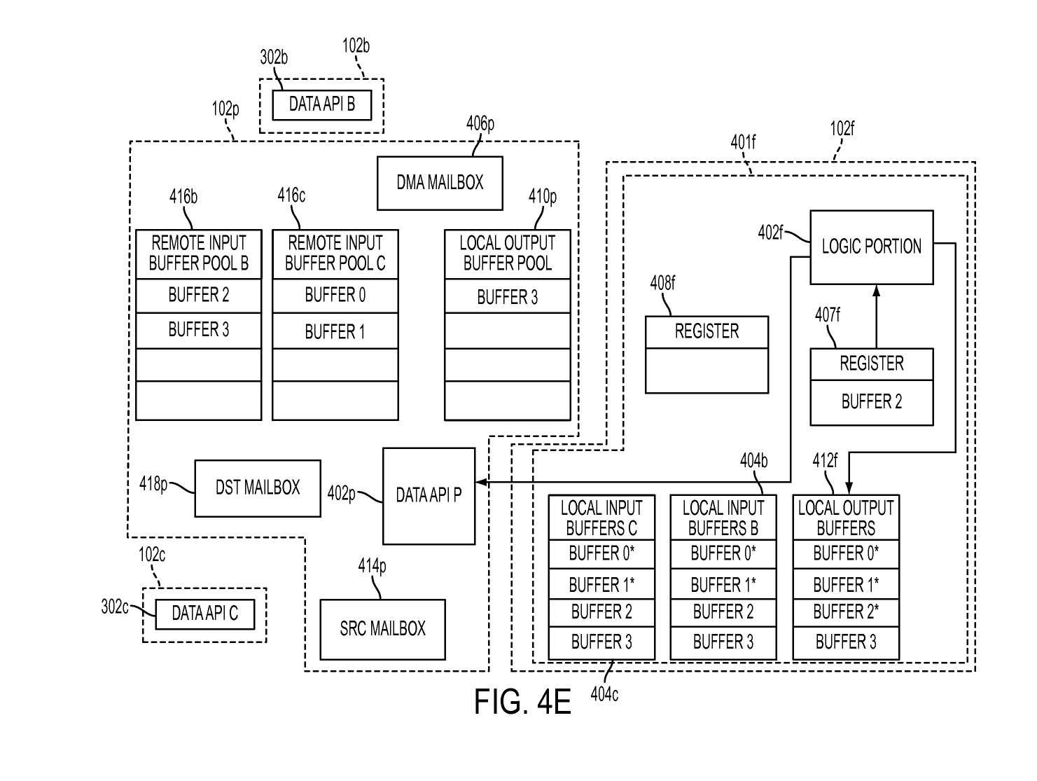

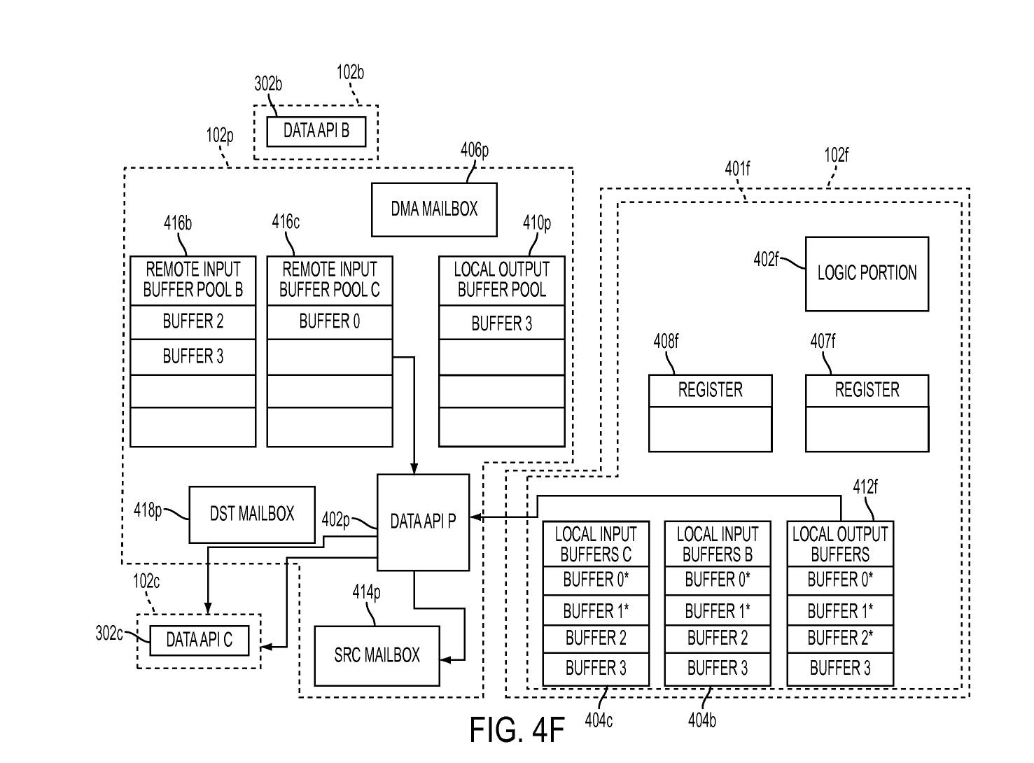

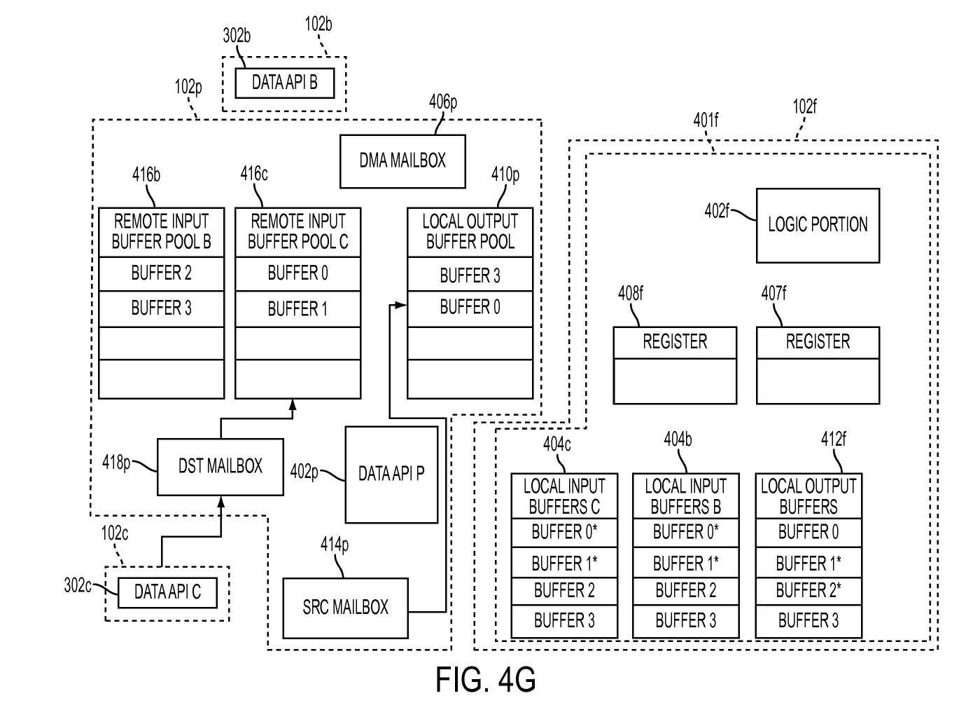

FIGS. 4A-4G illustrate an exemplary embodiment of a node 102f that includes a FPGA 401f having a logic portion 402f as opposed to a CPU. The node 102f is associated with a node 102p that is designated as a proxy node that performs similar functions as described above for the FPGA 401f as a proxy. The node 102f and 102p may be included as additional nodes in the system 100 (of FIG. 1). The node 102p includes a CPU and may perform in a similar manner as the nodes 102a-c described above as well as performing the proxy functions described below. In this regard, the FPGA 401f includes a logic portion 402f that is operative to process data elements. The FPGA 401f includes a register 408f that is used by the logic portion 402f to process data elements. The local input buffers B and C 404b and c are operative to receive and store data elements from the nodes 302b and c respectively. Though two local input buffers 404c and b are shown for simplicity, the node 102f may include any number of local input buffers 404 that may each be allocated to particular nodes 102 of the system 100. The local output buffers 412f are operative to store and output processed data elements (e.g., data elements that have been processed and output by the logic portion 4020. The proxy node 102p includes a data API P 402p that is operative to perform similar functions as the data API 302 described above in FIG. 3. The data API 402p is operative to maintain generate DMA threads for data elements sent from the node 102f and manage the local input buffers 404f of the node 102f.

An exemplary method for receiving data in the node 102f is described below. In this regard, referring to FIG. 4B, a data element has been saved in the local input buffer 404b of node 102f by the node 102b as indicated for illustrative purposes by the “*” in the buffer 1 of the local input buffer 404b. The node 102b sends a message to the DMA mailbox 406p in the proxy node 102p.

Referring to FIG. 4C, DMA mailbox 406p sends a message to the data API 402p to indicate that a data element is saved in the local input buffer 404b buffer 1. The data API 402p receives the message from the DMA mailbox 406p and writes the buffer address of the saved data element (e.g., an address to buffer 1 of the local input buffers B 404b) in the register 408f. The data API 402p sends an interrupt message to the logic portion 402f indicating that a data element is ready for processing at the address stored in the register 408f. When the logic portion 402f receives the interrupt message, the logic portion 402f retrieves the address stored in the register 408f and uses the address to retrieve the data element stored at the address of the local input buffer 404b.

Referring to FIG. 4D, the data API 402p retrieves an address from the local output buffer pool 410p that includes a list of “empty” (e.g., buffers that are available to be overwritten) in the local output buffer 412f. The data API 402p sends the address to the register 407f. The API 402p may continually populate the register 407f with an address of an available local output buffer 412f when the API 402p determines that the register 407f is available (e.g., by receiving an interrupt message from the logic portion 4020, and an address is available in the local output buffer 412f.

Referring to FIG. 4E, the logic portion 402f retrieves the address from the register 407f and uses the address to save the processed data element in addressed memory location in the local output buffer 412f as indicated for illustrative purposes by the “*” in the buffer 2 of the local output buffer 412f. Once the logic portion 402f has retrieved the address from the register 407f, the logic portion 402 sends an interrupt message to the API 402p indicating that the register 407f is available.

When the processed data element is saved in the local output buffer 412f, the logic portion 402f sends an interrupt message to the data API 402p indicating that the data element should be sent to another node 102. The data API may then retrieve another message from the DMA mailbox 406p to send another received data element saved in one of the local input buffers 404 to the logic portion 402f using a similar method as described above.

Referring to FIG. 4F, the API 402p retrieves data from the local output buffer 412f and sends the data to another node (a receiving node) in the system 100. In the illustrated example, the data API 402p has retrieved a processed data element from the buffer 0 location of the local output buffer 412f to save the processed data element in the receiving node, node 102c. The API 402p determines whether the local input buffer of the node 102c allocated to the node 102f (e.g., local input buffers F, not shown) has a buffer that is “empty” or available to save the processed data element. The API 402p retrieves an available address from the remote input buffer pool C 416c that indicates the addresses available in the local input buffers F of the node 102c (not shown). When an address is available as indicated by the presence of the address in the remote input buffer pool C 416c (e.g., buffer 1 in the remote input buffer pool C 416c shown in FIG. 4E), the data API 402p removes the address from the remote input buffer pool C 416c and uses the address to generate a DMA thread with the processed data element in the local output buffer (e.g., the processed data element stored in the buffer 0 of the local output buffer 412f. When the data API 402p saves the processed data element in the buffer 1 of the local input buffer of the node 102c, the data API 402p sends a message to the src mailbox 414p indicating that the buffer 0 of the local output buffer 412f is available to be overwritten. The data API 402p also sends a message to the DMA mailbox of the receiving node, node 102c that may be used to update the local input buffer pool of the receiving node, 102c as described above.

Referring to FIG. 4G, the local output buffer pool 410p has been updated by retrieving the message from the src mailbox 414p that indicates that the buffer 0 of the local output buffer 412f is “empty” or available to be overwritten. Once the node 102c has processed the received data element, by retrieving the received data element from the buffer 1 of the local input buffer F in the node 102c (not shown), the node 102c sends a message to the dst mailbox 418p of the node 102p that indicates that the buffer 1 of the local input buffer F in the node 102c is “empty” or available to be overwritten. The remote input buffer pool C 416c may be updated by receiving the message from the dst mailbox 418p and adding the buffer 1 to the list in the remote input buffer pool C 416c.

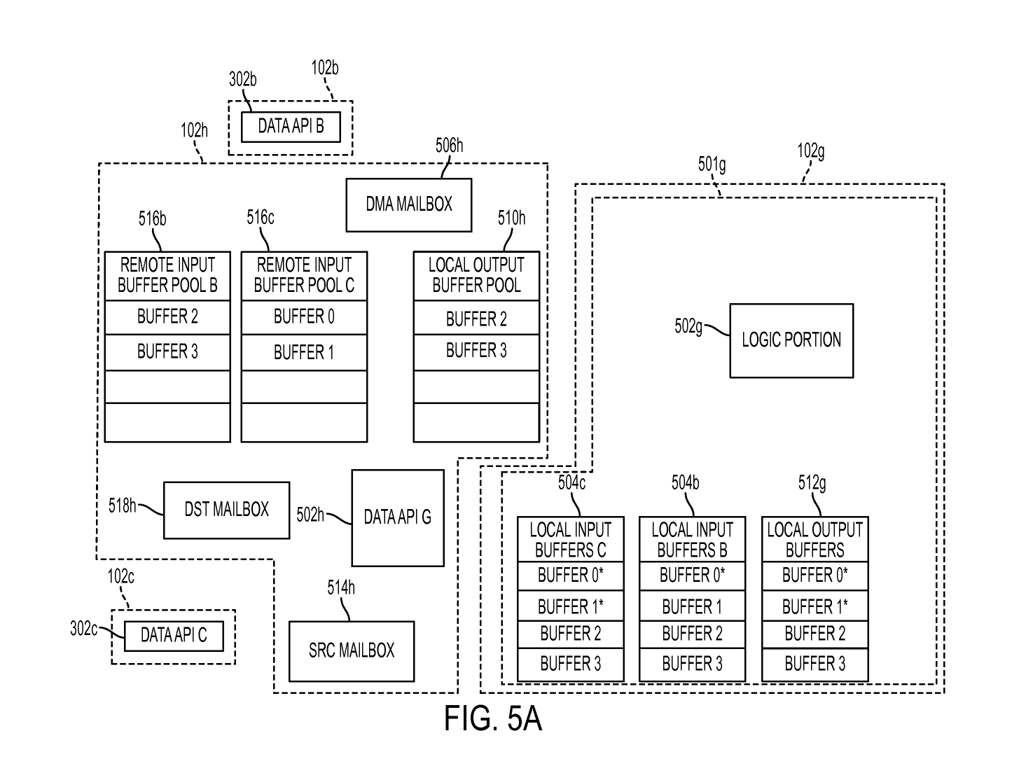

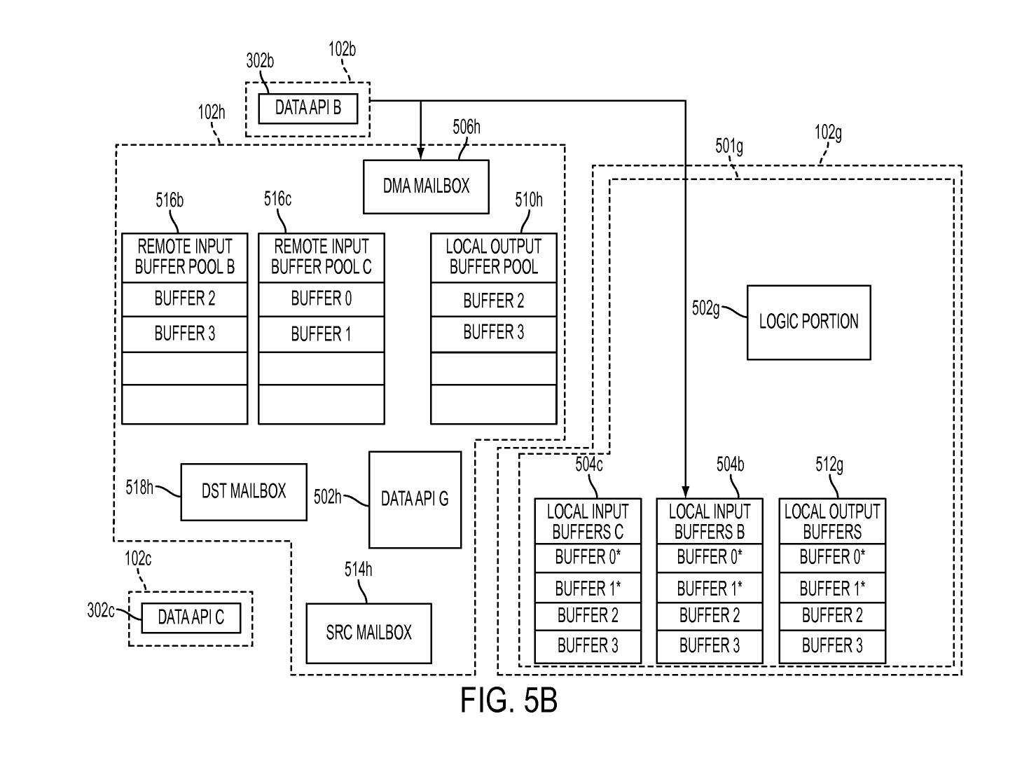

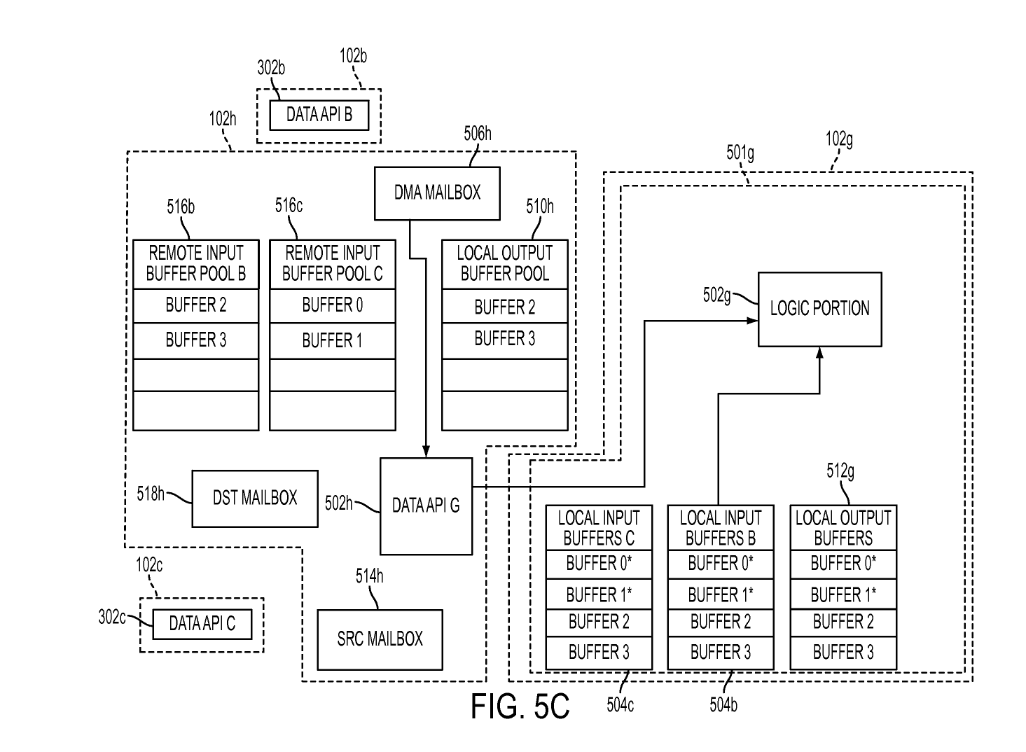

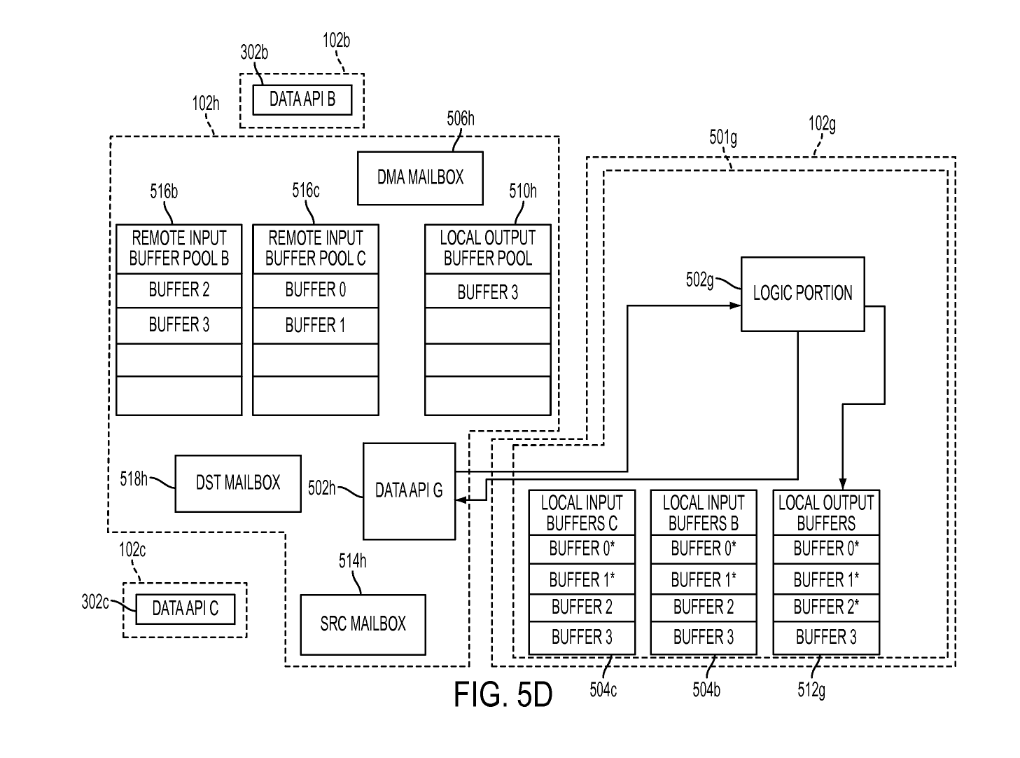

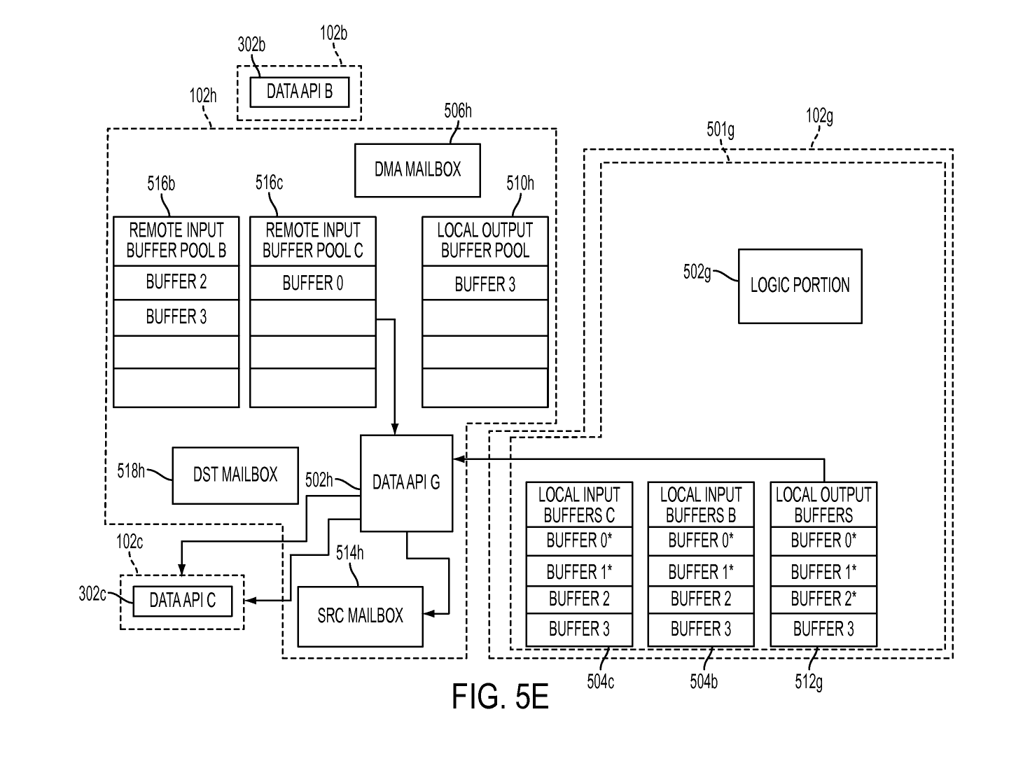

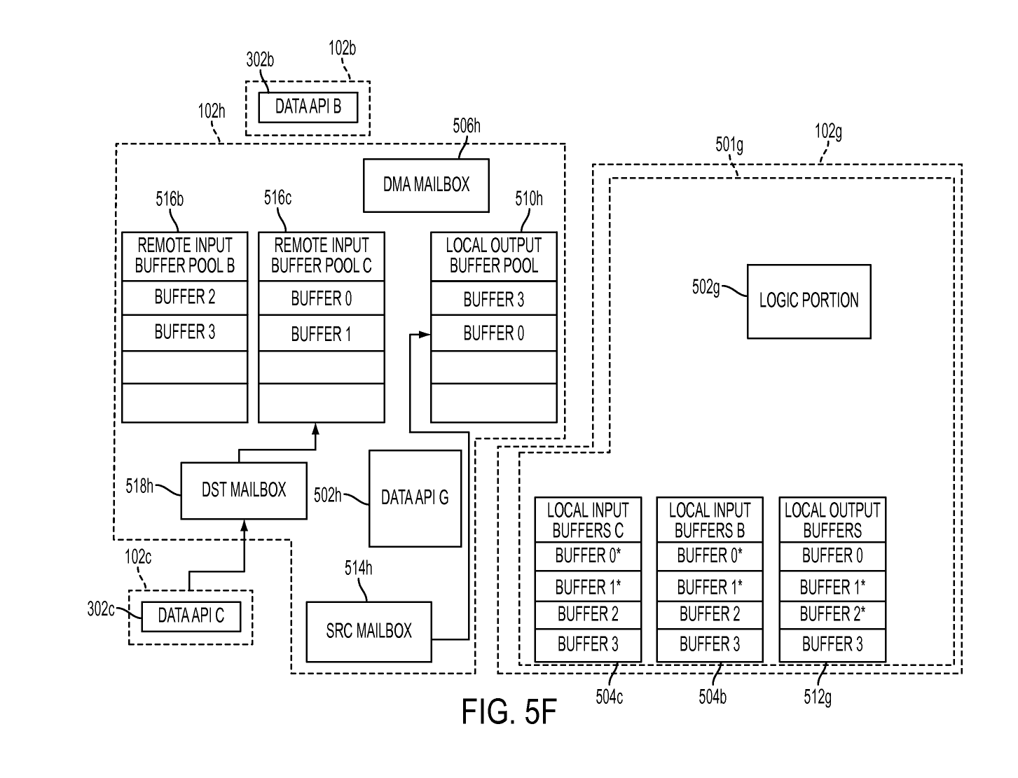

FIGS. 5A-5F illustrate an exemplary embodiment of a node 102g that includes a graphics processing unit GPU 501g having a logic portion 502g as opposed to a CPU. The node 102f is associated with a node 102h that is designated as a proxy node that performs similar functions as described above for the GPU 501g as a proxy. The nodes 102g and 102h may be included as additional nodes in the system 100 (of FIG. 1). The node 102h includes a CPU and may perform in a similar manner as the nodes 102a-c described above as well as performing the proxy functions described below. In this regard, the GPU 501g includes a logic portion 502g that is operative to process data elements. The local input buffers B and C 504b and c are operative to receive and store data elements from the nodes 302b and 302c respectively. Though two local input buffers 504c and b are shown for simplicity, the node 102g may include any number of local input buffers 504 that may each be allocated to particular nodes 102 of the system 100. The local output buffers 512g are operative to store and output processed data elements (e.g., data elements that have been processed and output by the logic portion 502g). The proxy node 102h includes a data API G 502h that is operative to perform similar functions as the data API 402 described above in FIG. 4. The data API 502h is operative to maintain generate DMA threads for data elements sent from the node 102g and manage the local input buffers 504g of the node 102g.

An exemplary method for receiving data in the node 102g is described below. In this regard, referring to FIG. 5B, a data element has been saved in the local input buffer 504b of node 102g by the node 102b as indicated for illustrative purposes by the “*” in the buffer 1 of the local input buffer 504b. The node 102b sends a message to the DMA mailbox 506h in the proxy node 102h.

Referring to FIG. 5C, DMA mailbox 506h sends a message to the data API 502h to indicate that a data element is saved in the local input buffer 504b buffer 1. The data API 502h receives the message from the DMA mailbox 506h, and the data API 502h retrieves an address from the local output buffer pool 510h that includes a list of “empty” (e.g., buffers that are available to be overwritten) in the local output buffer 512h. The data API 502h sends an instruction to the logic portion 502g indicating that a data element is ready for processing at the address of the buffer 1 in the local input buffer 504b and including the retrieved available address of the local output buffer pool 510h. When the logic portion 502g receives the instruction, the logic portion 502g uses the address to retrieve the data element stored at the address of the local input buffer 504b.

Referring to FIG. 5D, once the logic portion 502g has processed the data element, the logic portion 502g uses the address of the local output buffer pool 510h received in the instruction to save the processed data element in addressed memory location in the local output buffer 512g as indicated for illustrative purposes by the “*” in the buffer 2 of the local output buffer 512g. When the processed data element is saved in the local output buffer 512g, the logic portion 502g sends a message to the data API 502h indicating that the data element has been saved. The data API may then retrieve another message from the DMA mailbox 506h to send another received data element saved in one of the local input buffers 504 to the logic portion 502g using a similar method as described above.

Referring to FIG. 5E, the API 502h retrieves data from the local output buffer 512g and sends the data to another node (a receiving node) in the system 100. In the illustrated example, the data API 502h has retrieved a processed data element from the buffer 0 location of the local output buffer 512p to save the processed data element in the receiving node, node 102c. The API 502h determines whether the local input buffer of the node 102c allocated to the node 102g (e.g., local input buffers G, not shown) has a buffer that is “empty” or available to save the processed data element. The API 502h retrieves an available address from the remote input buffer pool C 516c that indicates the addresses available in the local input buffers F of the node 102c. When an address is available as indicated by the presence of the address in the remote input buffer pool C 516c (e.g., buffer 1 in the remote input buffer pool C 516c shown in FIG. 5D), the data API 502h removes the address from the remote input buffer pool C 516c and uses the address to generate a DMA thread with the processed data element in the local output buffer (e.g., the processed data element stored in the buffer 0 of the local output buffer 512g. When the data API 502h saves the processed data element in the buffer 1 of the local input buffer of the node 102c, the data API 502h sends a message to the src mailbox 514h indicating that the buffer 0 of the local output buffer 512g is available to be overwritten. The data API 502h also sends a message to the DMA mailbox of the receiving node, node 102c that may be used to update the local input buffer pool of the receiving node, 102c as described above.

Referring to FIG. 5F, the local output buffer pool 510h has been updated by retrieving the message from the src mailbox 514h that indicates that the buffer 0 of the local output buffer 512g is “empty” or available to be overwritten. Once the node 102c has processed the received data element, by retrieving the received data element from the buffer 1 of the local input buffer F in the node 102c (not shown), the node 102c sends a message to the dst mailbox 518h of the node 102h that indicates that the buffer 1 of the local input buffer G in the node 102c is “empty” or available to be overwritten. The remote input buffer pool C 516c may be updated by receiving the message from the dst mailbox 518h and adding the buffer 1 to the list in the remote input buffer pool C 516c.

The technical effects and benefits of the embodiments described herein provide a method and system for saving data using a DMA thread in memory locations located on nodes of a system without using command and control messages that consume system resources. The method and system provides high bandwidth transfers of data between nodes and decreases overall system processing time by reducing data transfer times between nodes.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for transferring data between nodes, the method comprising:
receiving in an input buffer of a first node, a direct memory access (DMA) thread that includes a first data element, the input buffer associated with a second node;
receiving a first message from the second node indicative of an address of the input buffer containing the first data element; and
saving the address of the input buffer containing the first data element to a first list responsive to receiving the first message.

2. The method of claim 1, wherein the method further comprises:
retrieving the address of the input buffer containing the first data element from the first list;
retrieving the first data element from the input buffer of the first node; and
processing the first data element in the first node to generate a processed first data element.

3. The method of claim 2, wherein the method further comprises sending a second message from the first node to the second node indicative that the address of the input buffer containing the first data element is available to be overwritten responsive to processing the first data element in the first node.

4. The method of claim 2, wherein the method further comprises removing the address of the input buffer containing the first data element from the first list responsive to retrieving the first data element from the input buffer of the first node.

5. The method of claim 2, wherein the method further comprises:
retrieving an address of an available output buffer from a second list responsive to processing the first data element;
saving the processed first data element in the received address of the available output buffer; and
removing the address of the available output buffer from the second list responsive to saving the processed first data element in the received address of the available output buffer.

6. The method of claim 1, wherein the method further comprises:
retrieving an address of an available input buffer of the second node from a third list, the input buffer associated with the first node;
retrieving a processed data element from an output buffer of the first node;
generating a data packet that includes the processed data element; and
sending the data packet to the address of the available input buffer of the second node.

7. The method of claim 6, wherein the method further comprises removing the address of the available input buffer of the second node from the third list responsive to generating the data packet.

8. The method of claim 6, wherein the method further comprises adding an address of the output buffer of the first node that included the retrieved processed data element to a list of available output buffers responsive to generating the data packet.

9. The method of claim 6, wherein the method further comprises sending a second message from the first node to the second node indicative the address of the available input buffer of the second node that includes the sent data packet.

10. The method of claim 1, wherein the method further comprises receiving a third message from the second node indicative that an input buffer of the second node the input buffer associated with the first node, is available to be overwritten.

11. The method of claim 10, wherein the method further comprises adding an address of input buffer of the second node that is available to be overwritten to a third list associated with the input buffer of the second node responsive to receiving the third message.

12. A processing node comprising:
a memory device; and
a processor operative to perform a method comprising:
receiving in an input buffer of a first node, a direct memory access (DMA) thread that includes a first data element, the input buffer associated with a second node;
receiving a first message from the second node indicative of an address of the input buffer containing the first data element; and
saving the address of the input buffer containing the first data element to a first list responsive to receiving the first message.

13. The processing node of claim 12, wherein the method further comprises:
retrieving the address of the input buffer containing the first data element from the first list;
retrieving the first data element from the input buffer of the first node; and
processing the first data element in the first node to generate a processed first data element.

14. The processing node of claim 13, wherein the method further comprises sending a second message from the first node to the second node indicative that the address of the input buffer containing the first data element is available to be overwritten responsive to processing the first data element in the first node.

15. The processing node of claim 13, wherein the method further comprises removing the address of the input buffer containing the first data element from the first list responsive to retrieving the first data element from the input buffer of the first node.

16. The processing node of claim 13, wherein the method further comprises:
retrieving an address of an available output buffer from a second list responsive to processing the first data element;
saving the processed first data element in the received address of the available output buffer; and
removing the address of the available output buffer from the second list responsive to saving the processed first data element in the received address of the available output buffer.

17. The processing node of claim 12, wherein the method further comprises:
retrieving an address of an available input buffer of the second node from a third list, the input buffer associated with the first node;
retrieving a processed data element from an output buffer of the first node;
generating a data packet that includes the processed data element; and
sending the data packet to the address of the available input buffer of the second node.

18. The processing node of claim 17, wherein the method further comprises removing the address of the available input buffer of the second node from the third list responsive to generating the data packet.

19. The processing node of claim 17, wherein the method further comprises adding an address of the output buffer of the first node that included the retrieved processed data element to a list of available output buffers responsive to generating the data packet.

20. The processing node of claim 17, wherein the method further comprises sending a second message from the first node to the second node indicative the address of the available input buffer of the second node that includes the sent data packet.
